(19) United States
(12) Patent Application Publication
(10) Pub. No.: US 2026/0360231 A1
(43) Pub. Date: Nov. 12, 2026

(54) AERIAL WARNING SYSTEM

(71) Applicant: Wistron Corporation, New Taipei City (TW)

(72) Inventors: TELUNG WU, New Taipei City (TW); YAO TSUNG CHANG, New Taipei City (TW); CHIH MIN WANG, New Taipei City (TW); YU HSIN YU, New Taipei City (TW); JUNG SHU HSIAO, New Taipei City (TW)

(21) Appl. No.: 19/291,727

(22) Filed: Aug. 6, 2025

(30) Foreign Application Priority Data
May 7, 2025 (TW) 114117196

(51) Int. Cl. G08B 5/36; F21V 8/00

(52) U.S. Cl. CPC G08B 5/36; G02B 6/0006

(57) ABSTRACT

An aerial warning system which includes a floatable object, a light-transmitting wire, and a first light source is presented. The light-transmitting wire has a first end connected to the floatable object and a second end opposite to the first end. The light-transmitting wire includes at least a light-emitting portion disposed between the first end and the second end. The first light source is disposed on the first end or the second end of the light-transmitting wire and emits a first incident light into the light-transmitting wire. At least a portion of the first incident light is emitted through at least a light-emitting portion of the light-transmitting wire. Another warning system which includes a floatable object, a rope, a plurality of light-transmitting wires, and a first light source is also presented. The rope is connected to the floatable object, and the light-transmitting wires surround the rope.

### CROSS REFERENCE TO RELATED APPLICATION

This application claims the priority benefit of Taiwan Patent Application No. 114117196, filed on May 7, 2025. The entirety of the mentioned above patent application is hereby incorporated by reference herein and made a part of this specification.

### BACKGROUND OF THE INVENTION

### 1. Field of the Invention

The present invention relates to an aerial warning system. Specifically, the present invention relates to an aerial warning system with a light-emitting tether.

### 2. Description of the Prior Art

For the sake of aviation safety, airborne objects are generally required to be equipped with warning devices while in flight, allowing visual identification from other aircraft. For example, aircraft must feature prominent colors to facilitate visual recognition during the daytime, and are further required to employ warning lights at night. As to objects tethered to the ground, such as tethered balloons, large kites, and airborne sails, since the tether may also pose a risk to other aircrafts, both the object and the tether should be marked with warning colors or lights. Since the tether typically has a small diameter which is not readily visible, additional lights or flags are commonly employed to enhance its visibility.

However, tethers with such additional lights or flags are not easy to wind and store. For instance, in airborne wind power generation systems, during the ascending mode, the sail is driven upward and outward by the wind, pulling the tether from a winch, which in turn drives an electrical generator. Once the sail reaches a distant position, the object must be retracted by pulling back the tether, and the tether is rewound onto the winch in preparation for the next ascending cycle. Protruding flags or lighting devices on the tether may hinder smooth retraction and winding. Furthermore, externally mounted lighting devices require electrical wiring to supply power. These wires, when attached externally to the tether, are prone to tangling during winding or may suffer from damage due to bending or pulling, resulting in poor electrical contact or wire breakage, thereby resulting in malfunction of the lighting devices.

Accordingly, the present invention provides an aerial warning system that enables illumination for visual warning without protruding lighting devices on the tether

### SUMMARY OF THE INVENTION

The present invention provides an aerial warning system including a light-transmitting wire with total internal reflection property, wherein a light source is configured to emit light into an end of the light-transmitting wire, and the light is emitted between both ends of the light-transmitting wire, enabling illumination for visual warning.

The present invention also provides an aerial warning system including a plurality of light-transmitting wires surrounding a rope, wherein the light-transmitting wires have total internal reflection property, and a light source is configured to emit light into an end of each light-transmitting wire, and the light is emitted between both ends of the light-transmitting wire, enabling illumination for visual warning on the outside of the rope.

In an embodiment of the present invention, the aerial warning system includes a floatable object, a light-transmitting wire, and a first light source. The light-transmitting wire has a first end and a second end opposite to the first end, wherein the first end is connected to the floatable object. The light-transmitting wire further includes at least one light-emitting portion disposed between the first end and the second end. The first light source is disposed on the first end or the second end of the light-transmitting wire. The first light source is configured to emit a first incident light into the light-transmitting wire, wherein at least a portion of the first incident light is emitted through the light-emitting portion of the light-transmitting wire.

In an embodiment of the present invention, the aerial warning system includes a floatable object, a rope, a plurality of light-transmitting wires, and a first light source. The rope is connected to the floatable object. The light-transmitting wires surrounds the rope. Each light-transmitting wire has a first end and a second end opposite to the first end, wherein the first end is connected to the floatable object. Each light-transmitting wire further includes at least one light-emitting portion disposed between the first end and the second end. The first light source is connected to the first end or the second end of each light-transmitting wires and includes a plurality of light-emitting units corresponding to the plurality of light-transmitting wires. For each light-transmitting wire, the corresponding light-emitting unit is configured to emit a first incident light into the light-transmitting wire, and at least a portion of the first incident light is emitted through the light-emitting portion of the light-transmitting wire.

In an embodiment, the aerial warning system includes more than one light-emitting portions. The light-emitting portions are arranged along the light-transmitting wire with predetermined intervals therebetween.

In an embodiment, the light-emitting portion includes a plurality of microstructures.

In an embodiment, a portion of the microstructures relatively closer to the first light source is more loosely arranged, and another portion of microstructures relatively away from the first light source is more closely arranged.

In an embodiment, the light-emitting portion has an uneven surface.

In an embodiment, the light-transmitting wire includes an inner material and an outer material. The outer material encloses the inner material, and the refractive index of the outer material is less than the refractive index of the inner material.

In an embodiment, the light-transmitting wire includes an inner material and an outer material. The outer material encloses the inner material and has at least one light-guiding region corresponding to the at least one light-emitting portion.

In an embodiment, the aerial warning system further includes a control box, wherein the control box includes a power source and is electrically connected to the first light source.

In an embodiment, the aerial warning system further includes a pulling device, a motor, and an electric generator. The pulling device is connected to the second end of the light-transmitting wire, wherein the light-transmitting wire is configured to wind around the pulling device. The motor is disposed on the pulling device and configured to drive the pulling device to rotate. The electric generator is disposed on the pulling device to convert its rotation into electrical power.

In an embodiment, the aerial warning system further includes a second light source. The second light source is connected to the other one of the first end and the second end, and is configured to emit a second incident light into the light-transmitting wire. At least a portion of the second incident light is emitted through the light-emitting portion of the light-transmitting wire.

### BRIEF DESCRIPTION OF THE DRAWINGS

FIG. 1 is a schematic diagram of the aerial warning system in an embodiment.

FIG. 2 is an enlarged view of a portion of the aerial warning system in the embodiment shown in FIG. 1.

FIG. 3 is a schematic diagram of the light-transmitting wire in an embodiment.

FIG. 4 is a schematic diagram of the light-transmitting wire in another embodiment.

FIG. 5 is a schematic diagram of the light-transmitting wire in another embodiment.

FIG. 6 is an enlarged view of a portion of the aerial warning system in another embodiment.

FIG. 7 is a schematic diagram of the aerial warning system in another embodiment.

FIG. 8 is a schematic diagram of the aerial warning system in another embodiment.

FIG. 9 is an enlarged view of a portion of the aerial warning system in another embodiment.

FIG. 10 is a cross-sectional view of the light-transmitting wires and the rope of the aerial warning system in the embodiment shown in FIG. 9.

### DETAILED DESCRIPTION OF THE INVENTION

In the attached figures, for the purpose of clarification, the thicknesses of layers, films, panels, regions and the like are amplified. In the whole specification, the same marks represent the same element. It should be understood that, when an element such as a layer, a film, a panel, a region or a substrate is described as “being on” or “being connected to” another element, it may be directly on or connected to another element, or there may be other elements therebetween. On the other hand, when an element is described as “directly existing on” or “being directly connected to” another element, there is no element therebetween. As used in the present specification, a “connection” may be a physical and/or electrical connection.

The directional terminology used herein is intended to provide detailed descriptions and is not limiting to the present invention. For example, the relative terms “upper”, “lower”, and the like are merely used to describe the relative orientation between one and another element in the figures, depending on the specific viewing angle of the figures. In addition, the singular forms “a”, “an”, and “the” are intended to include the plural forms, including “at least one”, unless the content dictates otherwise. “Or” means “and/or”. The terms such as “first” and “second” are merely used to differentiate an element from another element. In the following discussions, a first element may be called a second element and do not depart from the teaching of the present invention.

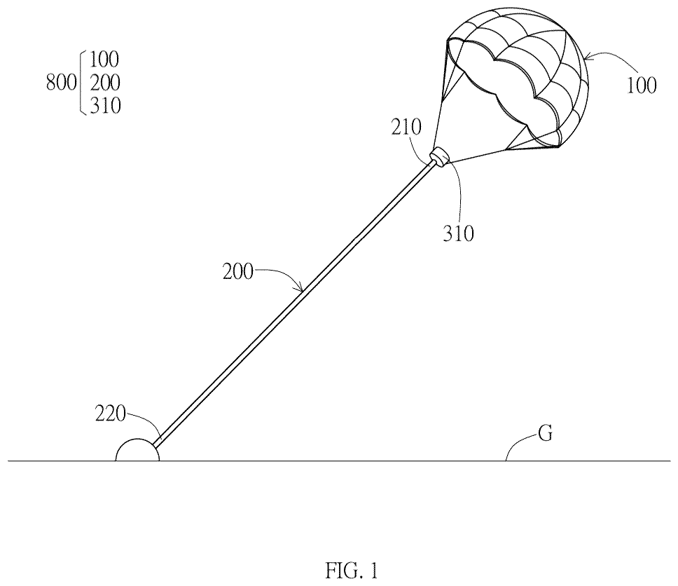

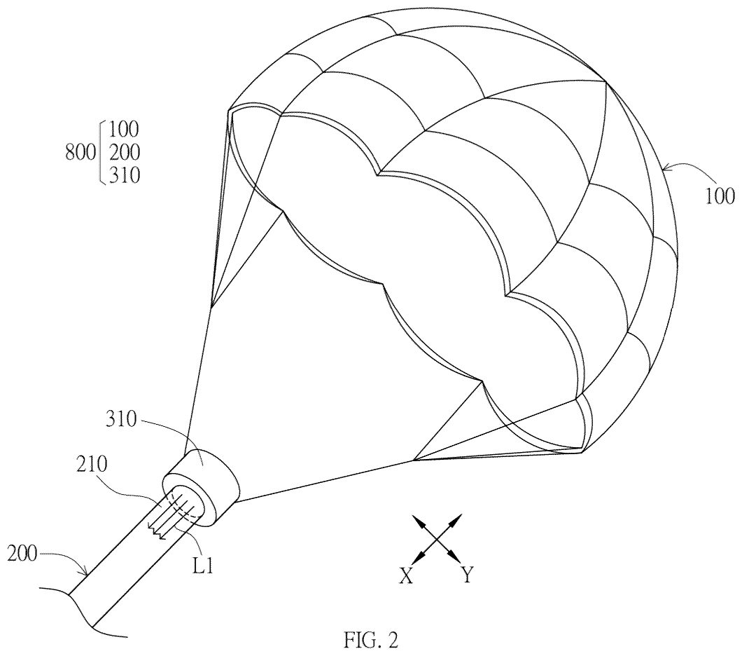

As shown in FIGS. 1 and 2, an embodiment of the present invention provides an aerial warning system 800, which includes a floatable object 100, a light-transmitting wire 200, and a first light source 310. The light-transmitting wire 200 has a first end 210 and a second end 220 opposite to the first end 210, wherein the first end 210 is connected to the floatable object 100. The light-transmitting wire 200 may exhibit a total internal reflection property and includes at least one light-emitting portion 230 disposed between the first end 210 and the second end 220. A first light source 310 is disposed on the first end 210 or the second end 220 of the light-transmitting wire 200. The first light source 310 is configured to emit a first incident light L1. The first incident light L1 is introduced into the light-transmitting wire 200, and at least a portion of the first incident light L1 is emitted between the first end 210 and the second end 220 of the light-transmitting wire 200. For example, a portion of the first incident light L1 can travel through the light-transmitting wire 200 and be emitted through the light-emitting portion 230.

In this embodiment, the first end 210 of the light-transmitting wire 200 may be directly or indirectly connected to the floatable object 100. For example, the first end 210 may be connected to the floatable object 100 with the first light source 310 therebetween. In addition, the second end 220 of the light-transmitting wire 200 may be connected to the ground G (as shown in FIG. 1), a fixed facility, or a movable object.

Specifically, the floatable object 100 can be lifted into the air by means of buoyancy or other propulsion mechanisms. The floatable object 100 may include a balloon, a kite, a paraglider, an airborne sail, and the like. The floatable object 100 may also equipped with power-assisted propulsion devices such as fans, propellers, deflectors, and the like. In other words, the floatable object 100 can remain airborne. Furthermore, the light-transmitting wire 200 may be an optical fiber, preferably a side-emitting optical fiber, and have sufficient tensile mechanical strength. The light-transmitting wire 200 may include light-transmitting material such as plastics, glass, or other polymers, but not limited thereto. Based on varying applications and designs, the first light source 310 may include fluorescent lamps, halogen lamps, light-emitting diodes (LEDs), lasers, and the like. The first incident light L1 includes, but is not limited to, lights of various wavelength ranges, including white light, visible light of different colors, ultraviolet (UV) light, and the like.

The light-transmitting wire 200 may feature a flexible elongated cylindrical shape or other shapes. The longitudinal direction of the light-transmitting wire 200 is defined as the axial direction X, extending from the first end 210 to the second end 220. Moreover, the axial direction X adjusts dynamically with the bending of the light-transmitting wire 200 and is respectively defined for each portion of the light-transmitting wire 200. The radial direction Y is perpendicular to the axial direction X, pointing toward the inner side face (which is parallel to the axial direction X) of the light-transmitting wire 200. As shown in FIG. 2, the first incident light L1 is introduced into the first end 210 of the light-transmitting wire 200 along the axial direction X and propagates substantially along the axial direction X in the light-transmitting wire 200. During the propagation, the first incident light L1 may be incident on the inner side face of the light-transmitting wire 200 and subsequently reflected and/or refracted on the inner side face. The light-transmitting wire 200 is designed to make the majority of light transmitted inside undergo total internal reflection. In other words, the light-transmitting wire 200 exhibits a total internal reflection property. Specifically, the refractive index of the light-transmitting wire 200 may be greater than the refractive index of the exterior environment (for example, air). When the incident angle of light on the inner side face of light-transmitting wire 200 exceeds the critical angle of total internal reflection, the incident light is totally reflected and does not exit the light-transmitting wire 200; when the incident angle of light on the inner side face of light-transmitting wire 200 falls below the critical angle of total internal reflection, a portion of the light is refracted and emitted through the light-transmitting wire 200, thus being observed from the outside of the light-transmitting wire 200. For example, at the bending points of light-transmitting wire 200, the incident angle of the first incident light L1 may increase, resulting in more light exiting from the side face (referring to lateral emission). Or, the local structure of the light-transmitting wire 200 (for example, at the light-emitting portion) can be adjusted to modify the intensity ratio of lateral emission to total incident light. The light source may be configured to provide axial illumination, that is, to introduce light into the end face of the light-transmitting wire 200 intersecting the axial direction X, which is more likely to meet the condition for total internal reflection. However, based on varying applications and designs, the light source may alternatively be positioned to provide lateral illumination.

In this specification, the term “axial illumination” refers to introducing light into the end face of the light-transmitting wire 200 intersecting the axial direction X, wherein the light enters substantially along the axial direction X. Apart from “axial illumination”, the term “lateral illumination” refers to introducing light into the side face of the light-transmitting wire 200, wherein the light may enter in a direction with components along both the axial direction X and the radial direction Y. Similarly, the term “lateral emission” refers to light leakage from the side face of the light-transmitting wire 200, wherein the light may exit in a direction with components along both the axial direction X and the radial direction Y.

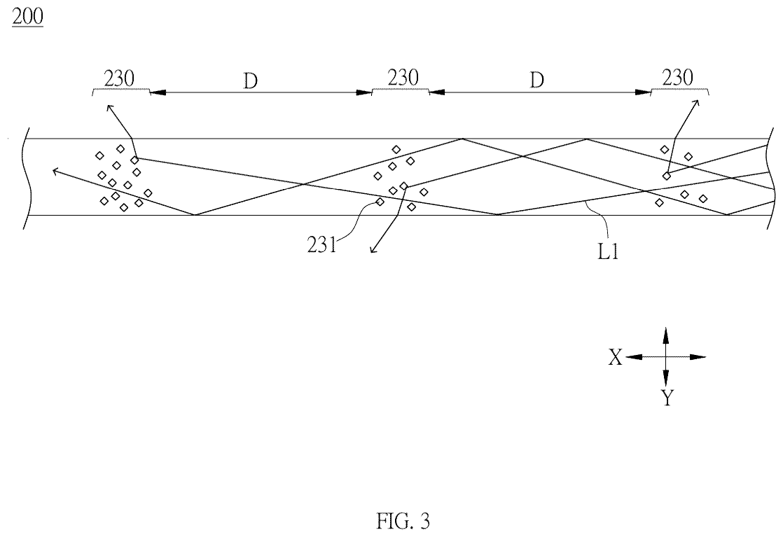

The light-transmitting wire 200 includes one or more light-emitting portions 230, wherein at least a portion of the first incident light L1 is emitted through the light-emitting portions 230, as shown in FIG. 3. The light-emitting portions 230 can serve as luminous warning sites distributed along the light-transmitting wire 200, which provide more lateral emission than the other portion of the light-transmitting wire 200. Specifically, in order to achieve a concentrated luminous warning effect, the other portions of the light-transmitting wire 200 (that is, excluding the light-emitting portions 230) may be designed to emit nearly no light to the exterior. Furthermore, every two neighboring light-emitting portions 230 may be separated by a predetermined length D (which may vary between pairs) in the light-transmitting wire 200, wherein the predetermined length D may be adjusted depending on the needs. For example, when the floatable object 100 is at an altitude of several hundred meters above the ground or the light-transmitting wire 200 extends over a distance of several hundred meters, the predetermined length D may be defined as 50 to 100 meters, but not limited thereto.

In order to guide light to exit from the light-emitting portion 230, different materials, inner structures, or surface structures may be used in the light-emitting portions 230 to modify the incident angle distribution of light on the inner side face of the light-emitting portions 230. In the embodiment shown in FIG. 3, each of the light-emitting portions 230 further includes a plurality of microstructures 231 inside, causing the travel direction of light to change and spread in multiple directions. The microstructures 231 may have regular or irregular geometric shapes and be distributed with various patterns and densities. For example, one microstructure 231 may have different surface directions with another, resulting in non-uniform normal directions. When light hits the microstructures 231, diffuse reflection may occur, causing light to scatter in multiple directions. In addition, the microstructures 231 may be transparent, and the incident light may be refracted at the microstructures 231, resulting in light spreading out in various directions. Moreover, both reflection and refraction may occur when light is incident on the microstructures 231. Based on these configurations, the travel direction of at least a portion of light can undergo significant deflection in the light-emitting portion 230, wherein at least a portion of light bends toward the radial direction Y. Therefore, the incident angle of at least a portion of the inner side face of the light-emitting portion 230 may decrease and fail to meet the condition of total internal reflection, enabling at least a portion of the light to be refracted and exit from the light-emitting portion 230 to the exterior. For example, the microstructures 231 may include small particles or bubbles, wherein the small particles may be made of glass, ceramics, metals, metal oxides, fluorescent materials (such as organic fluorescent dyes or quantum dots), their mixtures, or the like. In some embodiment, the microstructures 231 include fluorescent materials and the first incident light L1 may include UV or visible light with relative shorter wavelengths. The fluorescent materials can absorb the first incident light L1 and subsequently emit visible light with relative longer wavelengths omnidirectionally. Regarding the manufacturing process, the small particles may be mixed with the material of the light-transmitting wire 200 during shaping, while the bubbles may be generated by using a laser to engrave the interior of the light-transmitting wire 200.

After undergoing multiple reflections and lateral emission, the intensity of the light is reduced. Therefore, the intensity of light in the light-transmitting wire 200 decreases with increasing distance from the first light source 310 (referring to FIG. 1). As shown in FIGS. 1 and 3, in an embodiment, the first light source 310 is disposed on the first end 210. A portion of the microstructures 231 which is relatively closer to the first light source 310 (that is, closer to the first end 210) is more loosely arranged; another portion of the microstructures 231 which is relatively away from the first light source 310 (that is, closer to the second end 220) is more closely arranged. In other words, the microstructures 231 in the light-emitting portions 230 closer to the first end 210 may have a first distribution density, and the in the light-emitting portions 230 closer to the second end 220 may have a second distribution density, wherein the second distribution density is higher than the first distribution density. In addition, the distribution density of the microstructures 231 may gradually increase from the first end 210 to the second end 220. Based on these configurations, the intensity ratio of lateral emission to total incident light can be adjusted in each light-emitting portion 230, balancing the intensity of lateral emission across different light-emitting portions 230. Alternatively, the first light source 310 may be disposed on the second end 220, and the microstructures 231 closer to the first end 210 may have higher distribution density (that is, more closely arranged) than the microstructures 231 closer to the second end 220. Furthermore, the length of each light-emitting portion 230 in the axial direction X may be adjusted to modify the intensity of lateral emission. For example, the light-emitting portion 230 relatively closer to the first light source 310 may be shorter, while the light-emitting portion 230 relatively away from the first light source 310 may be longer. Specifically, the distribution density of the microstructures 231 or the length of the light-emitting portions 230 can be adjusted to meet the intensity requirement of lateral emission. For example, when five light-emitting portions 230 are presented in the light-transmitting wire 200, each light-emitting portion 230 may be designed to emit 20% of the total intensity of the first incident light L1. The intensity ratio of lateral emission to total incident can be adjusted corresponding to the number of the light-emitting portions 230.

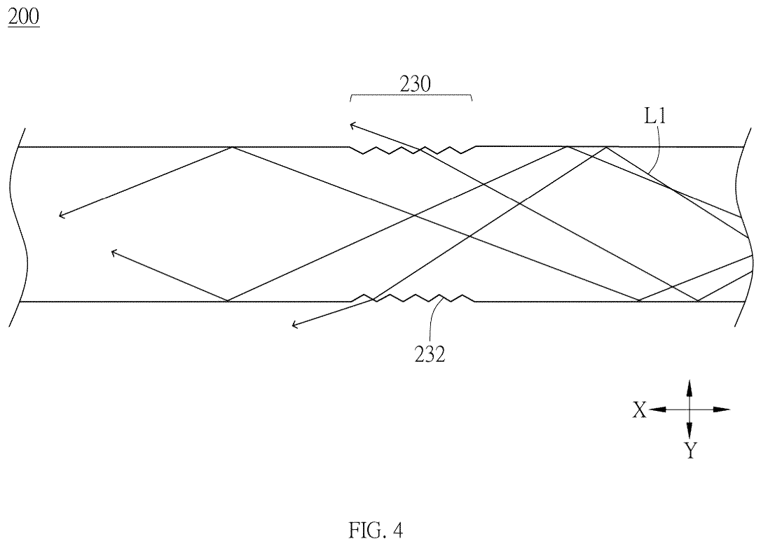

In the embodiment shown in FIG. 4, the light-emitting portion 230 may further have an uneven surface 232, which provides non-uniform normal directions across the inner side face of the light-emitting portion 230. Therefore, the incident angle of light on the inner side face of the light-emitting portion 230 is widely distributed, enabling a portion of light to be refracted and emitted outward. To elaborate, since the normal direction of at least a portion of the uneven surface 232 forms a relatively small angle with the axial direction X, when the light substantially traveling along the axial direction X hits the inner side face of the light-emitting portion 230, the incident angle is more likely to be less than the critical angle of total internal reflection. Specifically, the uneven surface 232 may be formed in a sawtooth shape, as shown in FIG. 4; alternatively, the uneven surface 232 may be shaped into other regular or irregular geometric patterns such as a rough surface generated by friction. The deepness of the uneven surface 232, which is defined as the vertical variation between the highest peak and the lowest valley of the surface, may be designed to be less than 1 mm to enable easy storage and maintain mechanical strength of the light-transmitting wire 200, but not limited thereto.

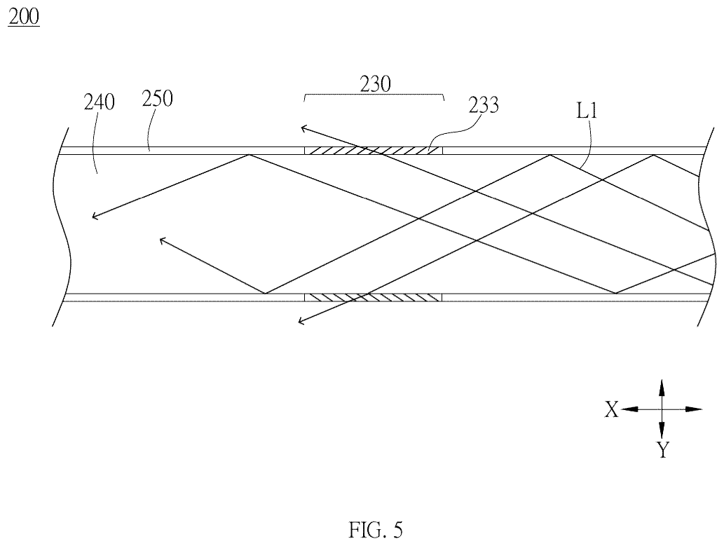

In an embodiment shown in FIG. 5, the light-transmitting wire 200 may further have an inner material 240 and an outer material 250, wherein the outer material 250 encloses the inner material 240. The refractive index of the outer material 250 is less than the refractive index of the inner material 240 to meet the condition of total internal reflection. Light can enter the inner material 240 and propagate in the inner material 240 with total reflection occurring on the interface between the inner material 240 and the outer material 250. The inner material 240 and the outer material 250 may include plastics, glass, or other polymers, but not limited thereto. The outer material 250 may further feature good mechanical strength and corrosion resistance to protect the inner material 240. Furthermore, in another embodiment, the outer material 250 may have one or more light-guiding regions 233 corresponding to the light-emitting portion 230, and the light-guiding regions 233 of the outer material 250 may have different materials or structures compared with other regions of the outer material 250. For example, the light-guiding regions 233 in the light-emitting portion 230 may have different materials or structures to enable lateral emission, including using a material exhibiting spatially varying refractive index, forming an uneven surface structure, using combined material to form multiple reflection faces and/or refraction faces to facilitate light bending toward the radial direction Y, and so on. The designs of the light-emitting portion 230 disclosed in the aforementioned embodiments can also be used in combination.

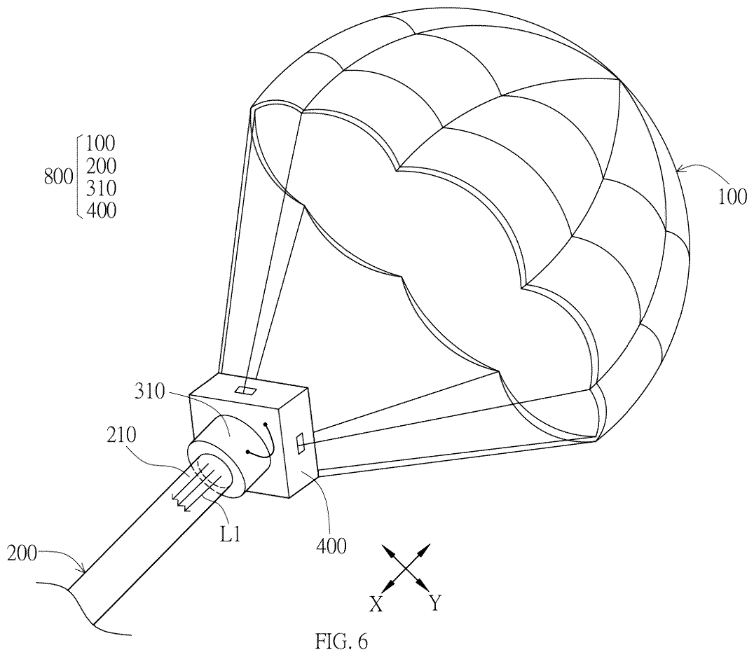

As shown in FIG. 6, in another embodiment of the present application, the aerial warning system 800 further includes a control box 400, which includes a power source and is electrically connected to the first light source 310. The power source of the control box 400 may include batteries, solar power generators, or wind power generators, providing electricity to the first light source 310. When the first light source 310 is disposed on the second end 220 and the second end 220 is close to the ground, the power source may be a power supply device installed on the ground (not shown in the figures). The control box 400 may control the operation states of the first light source 310 through manual switching, programming, remote control, or other methods, generating various luminous warning modes such as nighttime-only emission, flashing patterns, or color alternation. Moreover, the control box 400 may include a hook structure (not shown in the figures) on its casing for tying or hanging the first end 210 of the light-transmitting wire 200 to the control box 400. In addition, when the control box 400 is disposed on the first end 210 of the light-transmitting wire 200, the control box 400 may be further connected to the floatable object 100. For example, the control box 400 can be connected to the floatable object 100 (such as an airborne sail) via a control line, and the control line can be pulled or released to steer the floatable object 100.

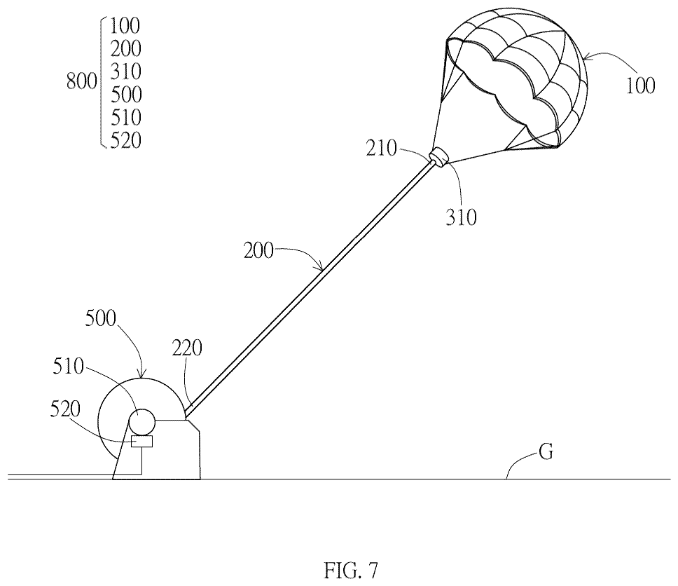

As shown in FIG. 7, in another embodiment of the present application, the aerial warning system 800 further includes a pulling device 500, a motor 510 and an electric generator 520. The pulling device 500 (such as a winch, a hoist, or a reeling mechanism) may be connected to the second end 220 of the light-transmitting wire 200, and the pulling device 500 may be disposed on the ground G. The light-transmitting wire 200 is configured to wind around the pulling device 500 for storage or adjusting the length of its extension. The motor 510 may be disposed on the pulling device 500 and configured to drive the pulling device 500 to rotate. The electric generator 520 may be disposed on the pulling device 500 to convert the rotation of the pulling device 500 to electricity, wherein the rotation of the pulling device 500 can be driven by the motion of the floatable object 100 through pulling the light-transmitting wire 200. For example, when an airborne sail, which serves as the floatable object 100, ascends under the force of the wind, the light-transmitting wire 200 is pulled outward, rotating the pulling device to release the light-transmitting wire 200, thus driving the electric generator 520 to produce electricity. To retract the sail or adjust its flying altitude, the motor 510 can be actuated to rotate the pulling device 500 in the reversed direction and pull back the light-transmitting wire 200. Since the light-transmitting wire 200 features inner lighting structures without protruding flags or lights, the light-transmitting wire 200 can be easily wound around the pulling device 500.

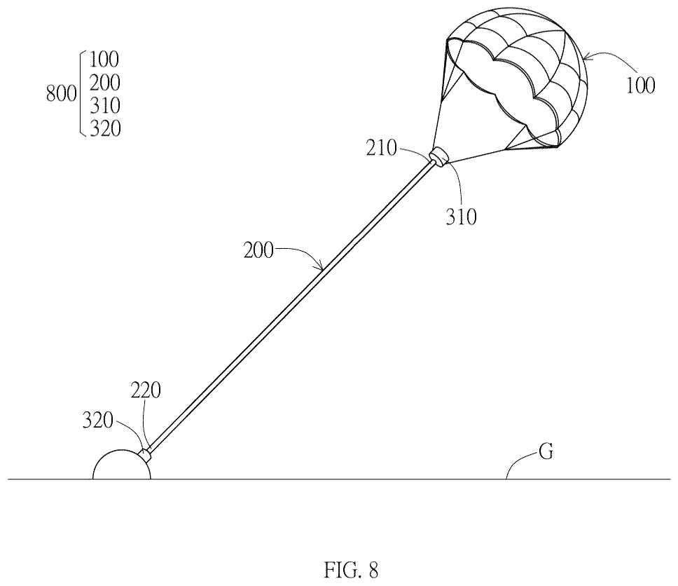

As shown in FIG. 8, in another embodiment of the present application, the aerial warning system 800 further includes a second light source 320. The second light source 320 is disposed on the other one of the first end 210 and the second end 220, which is opposite to the end connected to the first light source 310. That is, the first light source 310 and the second light source 320 are respectively disposed on the two ends of the light-transmitting wire 200. The second light source 320 is configured to emit a second incident light into the light-transmitting wire 200. For example, the second light source 320 may be disposed on the second end 220 of the light-transmitting wire 200 and facing toward the axial direction X, enabling the second incident light to be introduced into the second end 220 with axial illumination. Referring to FIG. 3, at least a portion of the second incident light can be emitted through the light-emitting portions 230 of the light-transmitting wire 200, where the emission position may be the same as or different from the first incident light L1. For example, the first incident light L1 and the second incident light may have different wavelength corresponding to the absorption wavelength of different fluorescence materials (such as red and blue fluorescence materials). The light-transmitting wire 200 may include two sets of light-emitting portions 230 respectively having red and blue fluorescence materials. Therefore, the first incident light L1 may be absorbed by red fluorescence materials in one set of light-emitting portions 230 and converted to red emission, while the second incident light may be absorbed by blue fluorescence materials in the other set of light-emitting portions 230 and converted to blue emission. Based on these configurations, the second light source 320 can provide additional light emission, increasing the intensity of lateral emission of the light-transmitting wire 200 close to the second end 220 and generating various lighting modes.

In another embodiment of the present application, the aerial warning system 800 may include a plurality of light-transmitting wires 200, and the first end 210 of each light-transmitting wire 200 receives a beam of the first incident light L1 emitted from the first light source 310. The light-transmitting wires 200 may be assembled through winding or weaving, or other materials may be integrated to form a combined tether with increased mechanical strength.

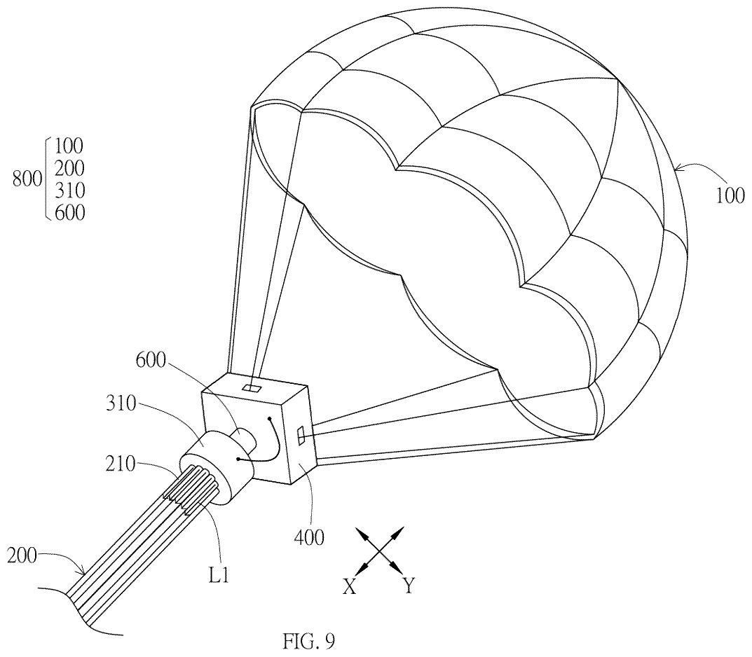

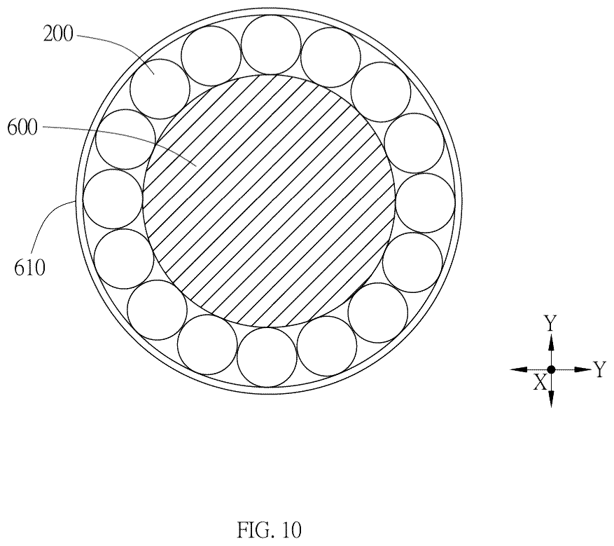

As shown in FIG. 9, in another embodiment of the present application, the aerial warning system 800 includes a floatable object 100, a rope 600, a plurality of light-transmitting wires 200, and a first light source 310. The rope 600 is connected to the floatable object 100. Specifically, the rope 600 can be the primary tension-bearing component between the floatable object 100 and the fixation or load at the other end. The rope 600 may include materials with good mechanical strength, corrosion resistance, or endurance under repeated bending cycles, including but not limited to polymers such as ultra-high molecular weight polyethylene (UHMWPE). The light-transmitting wires 200 are arranged around the rope 600, as shown in the profile in FIG. 10. An additional cushioning layer (not shown in the figures) may be disposed between the light-transmitting wires 200 and the rope 600, reducing the wear due to friction. The light-transmitting wires 200 may be wound or woven around the rope 600, or a protective layer 610 may be disposed to enclose the light-transmitting wires 200 and the rope 600 to form a combined tether. The protective layer 610 may be formed by transparent materials or have a mesh-like structure, allowing the lateral emission from the light-transmitting wires 200 to be visible from the outside.

Each light-transmitting wire 200 has a first end 210 and a second end 220 (referring to FIG. 7) opposite to the first end 210, wherein the first end 210 is connected to the floatable object 100 (referring to FIG. 9). The light-transmitting wire 200 may exhibit a total internal reflection property. The first light source 310 is connected to the first end 210 or the second end 220 of each light-transmitting wire 200. The first light source 310 includes a plurality of light-emitting units (not shown in the figures) corresponding to the plurality of light-transmitting wires 200, wherein the light-emitting units may be circularly arranged on the first light source 310 corresponding to the pattern of the first ends 210 or the second ends 220 of the light-transmitting wires 200 surrounding the rope 600 (referring to FIG. 10). For each light-transmitting wire 200, the corresponding light-emitting unit is configured to emit a beam of the first incident light L1 into the light-transmitting wire 200, and at least a portion of the first incident light L1 is emitted between the first end 210 and the second end 220 of the light-transmitting wire 200. Similar to the aforementioned embodiments, each light-transmitting wire 200 in this embodiment may include one or more light-emitting portions 230 served as luminous warning sites on the light-transmitting wire 200, wherein a portion of the first incident light L1 can exit from the light-emitting portion 230.

The aforementioned structural modifications can also be applied in this embodiment to adjust the incident angle distribution of light on the inner side face of the light-emitting portions 230. For example, the light-emitting portion 230 may include microstructures 231 on the inside (as shown in FIG. 3) or an uneven surface 232 on the outside (as shown in FIG. 4). On the other hand, the light-transmitting wire 200 may include an inner material 240 for light transmission and an outer material 250 with smaller refractive index surrounding the inner material 240. The outer material 250 may have one or more light-guiding regions 233 corresponding to the light-emitting portion 230, and the light-guiding regions 233 of the outer material 250 may have different materials or structures compared with other regions of the outer material 250 (as shown in FIG. 5). Based on these configurations, the first incident light L1 can be guided to exit the light-emitting portions 230, generating lateral emission.

In this embodiment, the aerial warning system 800 may further include the control box 400, a power source, the pulling device 500, the motor 510, the electric generator 520, the second light source 320, or combinations thereof (as shown in FIGS. 6 to 8), enabling controllable luminous warning effect, controllable flying modes, or wind power generation, but not limited thereto.

In addition, the same light-transmitting wire 200 may also be disposed on the outline of the floatable object 100, providing luminous warning effect on the floatable object 100 itself.

In summary, the present invention discloses an aerial warning system including a light-transmitting wire with total internal reflection property, wherein the light-transmitting wire can simultaneously serve as a luminous warning element and a tension-bearing tether connected to the floatable object. The light-transmitting wire has a substantially smooth surface, enabling convenient storage and adjustment of length. The present invention also discloses an aerial warning system with a combined tether including a rope and a plurality of light-transmitting wires with total internal reflection property, wherein the combined tether features both luminous warning function and mechanical strength. Furthermore, this aerial warning system can be integrated commercial devices that include built-in tension members, wherein light-transmitting wires and a light source can be added to the original structure, enabling an upgrade of luminous warning feature.

The present invention has been illustrated by the above embodiments. However, the above embodiments are only exemplary and are not to be regarded as limiting. Based on different designs, some components in one embodiment may be applied to another embodiment, but not limited thereto. The scope of the present invention is defined by the appended patent claims. Various changes and modifications to the present invention can be made by a person having ordinary skill in the art without departing from the spirit of the present invention, and that various changes and modifications fall within the scope of the present invention as defined by the appended patent claims.

1. An aerial warning system comprising:
a floatable object;
a light-transmitting wire having a first end and a second end opposite to the first end, wherein the first end is connected to the floatable object, and the light-transmitting wire comprises:
a plurality of light-emitting portions disposed between the first end and the second end and spaced apart from each other; and
a first light source disposed on one of the first end and the second end of the light-transmitting wire, wherein the first light source is configured to emit a first incident light into the light-transmitting wire, and at least a portion of the first incident light is emitted through the plurality of light-emitting portions of the light-transmitting wire.

2. The aerial warning system of claim 1, wherein each of the at plurality of light-emitting portions comprises a plurality of microstructures.

3. The aerial warning system of claim 2, wherein a portion of the plurality of microstructures relatively closer to the first light source is arranged with a first distribution density, another portion of the plurality of microstructures relatively away from the first light source is arranged with a second distribution density, and the second distribution density is higher than the first distribution density.

4. The aerial warning system of claim 3, further comprising:
a control box including a power source and electrically connected to the first light source;
a pulling device connected to the second end of the light-transmitting wire, wherein the light-transmitting wire is configured to wind around the pulling device;
a motor disposed on the pulling device and configured to drive the pulling device to rotate; and
an electric generator disposed on the pulling device.

5. The aerial warning system of claim 1, wherein each of the plurality of light-emitting portions has an uneven surface.

6. The aerial warning system of claim 1, wherein the light-transmitting wire comprises an inner material and an outer material, the outer material encloses the inner material, and a refractive index of the outer material is less than a refractive index of the inner material.

7. The aerial warning system of claim 1, wherein the light-transmitting wire comprises an inner material and an outer material, the outer material encloses the inner material and has plurality of light-guiding regions corresponding to the at plurality of light-emitting portions.

8. The aerial warning system of claim 1, further comprising a control box, wherein the control box includes a power source and is electrically connected to the first light source.

9. The aerial warning system of claim 1, further comprising:
a pulling device connected to the second end of the light-transmitting wire, wherein the light-transmitting wire is configured to be wound around the pulling device;
a motor disposed on the pulling device and configured to drive the pulling device to rotate; and
an electric generator disposed on the pulling device.

10. The aerial warning system of claim 1, further comprising a second light source, wherein the second light source is disposed on the other one of the first end and the second end, the second light source is configured to emit a second incident light into the light-transmitting wire, and at least a portion of the second incident light is emitted through the plurality of light-emitting portions of the light-transmitting wire.

11. An aerial warning system comprising:
a floatable object;
a rope connected to the floatable object;
a plurality of light-transmitting wires surrounding the rope, each the plurality of light-transmitting wire having a first end and a second end opposite to the first end, wherein the first end is connected to the floatable object, and each of the plurality of light-transmitting wires includes a plurality of light-emitting portions disposed between the first end and the second end and space apart from each other; and
a first light source connected to one of the first end and the second end of each of the plurality of light-transmitting wires, wherein the first light source includes a plurality of light-emitting units corresponding to the plurality of light-transmitting wires;
for each of the plurality of light-transmitting wires, the light-emitting unit corresponding to the light-transmitting wire is configured to emit a first incident light into the light-transmitting wire, and at least a portion of the first incident light is emitted through the plurality of light-emitting portions of the light-transmitting wire.

12. The aerial warning system of claim 11, wherein the plurality of light-emitting units is circularly arranged corresponding to the first ends or the second ends of the plurality of light-transmitting wire.

13. The aerial warning system of claim 11, wherein the plurality of light-emitting portions comprises a plurality of microstructures.

14. The aerial warning system of claim 13, wherein a portion of the plurality of microstructures relatively closer to the first light source is arranged with a first distribution density, another portion of the plurality of microstructures relatively away from the first light source is arranged with a second distribution density, and the second distribution density is higher than the first distribution density.

15. The aerial warning system of claim 11, wherein each of the plurality of light-emitting portions has an uneven surface.

16. The aerial warning system of claim 11, wherein the light-transmitting wire comprises an inner material and an outer material, the outer material encloses the inner material, and a refractive index of the outer material is less than a refractive index of the inner material.

17. The aerial warning system of claim 11, wherein the light-transmitting wire comprises an inner material and an outer material, the outer material encloses the inner material and has a plurality of light-guiding regions corresponding to the plurality of light-emitting portions.

18. The aerial warning system of claim 11, further comprising a control box, wherein the control box includes a power source and is electrically connected to the first light source.

19. The aerial warning system of claim 11, further comprising:
a pulling device connected to the second end of the light-transmitting wire, wherein the light-transmitting wire is configured to wind around the pulling device;
a motor disposed on the pulling device and configured to drive the pulling device to rotate; and
an electric generator disposed on the pulling device.

20. The aerial warning system of claim 11, further comprising a second light source, wherein the second light source is connected to the other one of the first end and the second end, the second light source is configured to emit a second incident light into the plurality of light-transmitting wire, and at least a portion of the second incident light is emitted through the plurality of light-emitting portions of the light-transmitting wire.
